(19) United States
(12) Patent Application Publication
(10) Pub. No.: US 2012/0106131 A1
(43) Pub. Date: May 3, 2012

(54) HEAT DISSIPATING STRUCTURE OF LIGHT SOURCE AND BACKLIGHT MODULE

(75) Inventor: YANXUE ZHANG, Shenzhen (CN)

(73) Assignee: Shenzhen China Star Optoelectronics Technology Co. LTD., Shenzhen City (CN)

(21) Appl. No.: 13/219,689

(22) Filed: Aug. 28, 2011

(30) Foreign Application Priority Data
Nov. 1, 2010 (CN) 201010527413.7

(51) Int. Cl. F21V 29/00; G09F 13/04; F21V 21/00

(52) U.S. Cl. 362/97.1; 362/249.02

(57) ABSTRACT

A heat dissipating structure of a light source and a backlight module are provided. The heat dissipating structure of the light source includes at least one load board, at least one LED package structure and a heat-dissipating base. The LED package structure is electrically connected to the load board. The heat-dissipating base has a first loading surface and at least one second loading surface. The height of the second loading surface is lower than that of the first loading surface. The LED package structure thermally contacts with the first loading surface of the heat-dissipating base, and the load board is separately disposed on the second loading surface of the heat-dissipating base. Therefore, the LED package structure may directly take the aid of the good heat-dissipating characteristic of the heat-dissipating base to conduct and dissipate heat, thereby relatively enhancing the heat-dissipating efficiency and the usage life of the LED package structure.

### BACKGROUND OF THE INVENTION

1. Field of the Invention

The present invention relates to a heat dissipating structure of a light source and a backlight module, and more particularly to a heat dissipating structure of a light source and a backlight module for a heat dissipating base directly contacting with a light emitting diode package structure, and for the light emitting diode package structure directly conducting and dissipating heat through the heat dissipating base.

2. Description of the Prior Art

A liquid crystal display (LCD) is a flat panel display (FPD), which can display images by characteristics of liquid crystal material. Comparing with other display devices, the LCD has many advantages of light and thin scale, low driving voltage, low power consumption and so on, and has been a dominant product of the whole consumption market. However, the liquid crystal material of the LCD can not emit light by self and must use a foreign light source, so the LCD needs to dispose a backlight module for providing the needed light source.

Generally, the backlight module may be divided into two modes of a side illumination backlight module and a direct illumination backlight module. The prior backlight module mainly employs a cold cathode fluorescent lamp (CCFL), a heat cathode fluorescent lamp (HCFL) or a semiconductor light emitting assembly as the light source. The semiconductor light emitting assembly mainly employs a light emitting diode (LED) to emit light, which, comparing with the cathode fluorescent lamps, is more energy-saving, more longer usage life, more light weight and small volume. Therefore, there is a trend of the cathode fluorescent lamps being replaced by the LED, and the LED will be a primary light source of the backlight module of the LCD in the future.

At present, the LED is taken as a chip to be disposed on a heat sink, and goes on to be packaged to form an LED package structure, and then is fixed on a bar-shaped circuit substrate and a bar-shaped aluminum extrusion material for forming a light bar (LB). Finally, a back of the light bar is combined with an aluminum heat dissipating plate of the backlight module so that forming a heat dissipating structure of a light source. However, the defects of the heat dissipating structure of the light source is that: the temperature of the LED chip in the LED package structure is extremely high during the working course, but the LED package structure only can indirectly transfer heat energy by the heat sink, the circuit substrate and the aluminum extrusion material. Because the print circuit board (PCB) between the LED package structure and the aluminum extrusion material is made of the high temperature insulation material, and can not assist the LED package structure to timely transfer the heat energy to the aluminum extrusion material and the aluminum heat dissipating plate. The result is that the temperature adjacent to the LED package structure will be significantly increased, and the temperature of every display zone of the LCD is so uneven that the LCD produces a phenomenon of slight red and the imaging quality thereof can be influenced.

Moreover, the luminous efficiency and the work stability of the LED itself are also extremely easy to be influenced because of the increase of the work temperature, and when serious, the usage life thereof may also be reduced because of being in a long-period high temperature state. In addition, if the light bar is only simply bonded on the aluminum heat dissipating plate by an adhesive, or only employs a bolt for being locked on the aluminum heat dissipating plate, and because the insulating adhesive is existed between the aluminum extrusion material and the aluminum heat dissipating plate of the light bar, the result is that the surfaces in between are neither in a direct thermal contact nor in a closely combination. That also influences the heat dissipating efficiency thereof in some extent, and more increases the thickness of the integral structure thereby being not helpful to the lightening and thinning design trend. Furthermore, in a long-period high temperature state, the adhesive may be denatured to lose glutinosity, resulting in the light bar being separated from the aluminum heat dissipating plate. If the heat energy of the LED package structure cannot be timely taken away by the aluminum heat dissipating plate, the LED package structure will have a risk of burning out due to excessive heat.

Hence, it is needed to provide a heat dissipating structure of a light source for the LED of the backlight module to solve the problem existed in the prior art.

### BRIEF SUMMARY OF THE INVENTION

An object of the present invention is to provide a heat dissipating structure of a light source, namely provide a heat dissipating structure of a light source for an LED to solve the heat-dissipating problem existed in the prior art.

A primary object of the present invention is to provide a heat dissipating structure of a light source, comprising at least one load board, at least one LED package structure and a heat-dissipating base. The at least one LED package structure is electrically connected to the at least one load board. The heat-dissipating base has a first loading surface and at least one second loading surface, wherein the at least one LED package structure thermally contacts with the first loading surface of the heat-dissipating base, and the at least one load board is separately disposed on the at least one second loading surface of the heat-dissipating base. Therefore, it is advantageous that the at least one LED package structure can take the aid of a good heat-dissipating characteristic of the heat-dissipating base to directly conduct and dissipate heat, thereby relatively enhancing the heat-dissipating efficiency and the usage life of the at least one LED package structure.

A secondary object of the present invention is to provide a heat dissipating structure of a light source, wherein the at least one LED package structure, the at least one load board and the heat-dissipating base are contacted with each other and combined together. Therefore the heat-dissipating base takes the aid of the first loading surface and the at least one second loading surface for directly contacting with a bottom surface of the at least one LED package structure and a lower surface of the at least one load board, respectively, without indirectly taking the aid of an aluminum extrusion material. It not only may simplify the structure and the assembly flow, but also may shorten working hours, and is advantageous for decreasing the assembly defective rate.

Another object of the present invention is to provide a heat dissipating structure of a light source, comprising at least one light bar and a heat-dissipating base. The at least one light bar each includes at least one LED package structure and at least one load board, wherein the heat-dissipating base has a first loading surface and at least one groove-shaped second loading surface. The at least one LED package structure of the at least one light bar contacts against the first loading surface of the heat-dissipating base. The at least one load board of the light bar is separately received and placed on the at least one groove-shaped second loading surface of the heat-dissipating base. Therefore, the at least one LED package structure and the at least one load board are directly and thermally contacting with the heat-dissipating base. Therefore it is advantageous that the at least one LED package structure and the at least one load board can take the aid of a good heat-dissipating characteristic of the heat-dissipating base to directly conduct and dissipate heat, thereby relatively enhancing the heat-dissipating efficiency and the usage life of the at least one LED package structure.

To achieve the aforementioned objects of the present invention, the present invention provides a heat dissipating structure of a light source, comprising at least one light bar, each including at least one LED package structure each having at least two terminals disposed on at least two sides of the LED package structure, and at least one load board electrically connected to the at least two terminals of the LED package structure; and a heat-dissipating base having a first loading surface and at least one second loading surface at least two second loading surface, wherein the at least one LED package structure of the at least one light bar are thermally contacting with the first loading surface of the heat-dissipating base, and the at least one load board of the at least one light bar is received and placed on the at least one second loading surface of the heat-dissipating base.

Moreover, the present invention provides another heat dissipating structure of a light source, characterized in that: the heat dissipating structure of the light source comprises at least one load board, at least one LED package structure being electrically connected to the at least one load board, and a heat-dissipating base having a first loading surface and at least one second loading surface, wherein the at least one LED package structure contacts against the first loading surface of the heat-dissipating base to form a thermally contact, and the at least one load board is separately disposed on the at least one second loading surface of the heat-dissipating base.

Furthermore, the present invention also provides another a backlight module of a heat dissipating structure of a light source, characterized in that: the backlight module comprises a heat dissipating structure of a light source, which includes at least one load board, at least one LED package structure being electrically connected to the at least one load board, and a heat-dissipating base having a first loading surface and at least one second loading surface, wherein the LED package structure thermally contacts with the first loading surface of the heat-dissipating base, and the at least one load board is separately disposed on the second loading surface of the heat-dissipating base.

In one embodiment of the present invention, the height of the second loading surface is lower than that of the first loading surface.

In one embodiment of the present invention, the second loading surface of the heat-dissipating base is groove-shaped.

In one embodiment of the present invention, the at least one heat dissipating structure of a light source further includes at least one LED chip.

In one embodiment of the present invention, the at least one load board is a printed circuit board, and the height of a top surface of the at least one load board is equal to that of the first loading surface.

In one embodiment of the present invention, the heat-dissipating base has at least two of the second loading surfaces. The LED package structure includes at least two terminals, which are disposed on at least two sides of the LED package structure and are separately and electrically connected to at least two of the load board.

In one embodiment of the present invention, the heat-dissipating base is a heat-dissipating aluminum extrusion.

Comparing with the prior art, the heat-dissipating base of the heat dissipating structure of the light source of the present invention may be simultaneously and directly combined with at least one LED package structure and the at least one load board without taking the aid of an aluminum extrusion material. The advantage of the at least one LED package structure, the at least one load board and the heat-dissipating base being combined together is that: the at least one LED package structure and the at least one load board can take the aid of the good heat-dissipating characteristic of the heat-dissipating base to directly conduct and dissipate heat, thereby relatively enhancing the heat-dissipating efficiency and the usage life of the at least one LED package structure.

### BRIEF DESCRIPTION OF THE DRAWINGS

FIG. 1A is a schematic view of a heat dissipating structure of a light source of a first embodiment of the present invention;

FIG. 1B is a side view of the heat dissipating structure of the light source of the first embodiment of the present invention;

FIG. 2 is a side view of a heat dissipating structure of a light source of a second embodiment of the present invention; and

FIG. 3 is a side view of a heat dissipating structure of a light source of a third embodiment of the present invention.

### DETAILED DESCRIPTION OF THE PREFERRED EMBODIMENTS

For more clearly and easily understanding the object, the feature and the advantage of the present invention, the following text will take a preferred embodiment of the present invention with reference to the accompanying drawings for detail description as follows. Moreover, directional terms mentioned in the present invention, such as “top”, “bottom”, “front”, “back”, “left”, “right”, “inside”, “outside”, “side” etc., are only used with reference to the orientation of the accompanying drawings. Therefore, the used directional terms are intended to illustrate, but not to limit, the present invention.

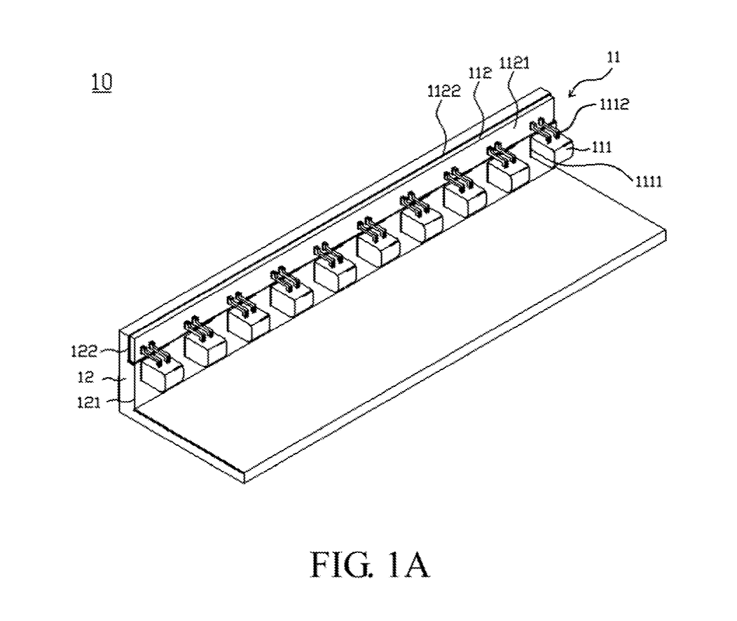

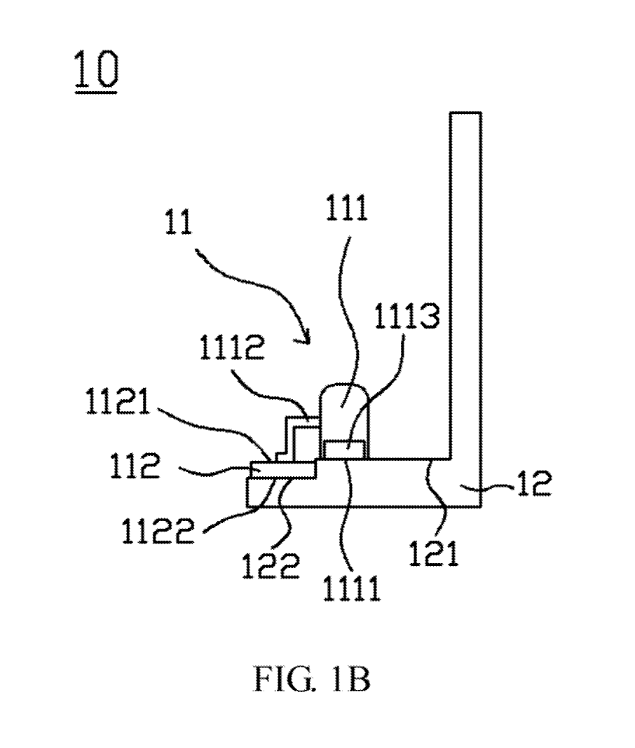

Please refer to FIG. 1A, which is a schematic view of a heat dissipating structure of a light source 10 of a first embodiment of the present invention, wherein the heat dissipating structure of the light source 10 of the first embodiment of the present invention is mainly applied to an illumination field or an LCD field, especially a backlight module of the LCD field. The heat dissipating structure of the light source 10 mainly includes at least one light bar 11 and a heat-dissipating base 12. The present invention will explain the above components in detail in the following text.

Please refer to FIG. 1B, which is a side view of the heat dissipating structure of the light source of FIG. 1A of the first embodiment of the present invention. The heat dissipating structure of the light source 10 of the first embodiment of the present invention is a heat dissipating structure of a light source of a side illumination backlight module. And the at least one light bar 11 is an LED light bar. The at least one light bar 11 may be mounted on at least one side of an optical film of a backlight module, but not be limited to this. For example, the at least one light bar 11 may be mounted under an optical film of a backlight module for being used as a backlight source of a direct illumination backlight module. Moreover, the at least one light bar 11 each includes at least one LED package structure 111 and a load board 112. The at least one LED package structure 111 each has a bottom surface 1111, at least two terminals 1112 and a heat sink 1113. The load board 112 has an upper surface 1121 and a lower surface 1122. The upper surface 1121 of the load board 112 is electrically connected to the at least two terminals 1112 of the at least one LED package structure 111. And the LED package structure 111 refers to an integral LED package body, the self of which includes, in order from the top down, a package adhesive body, at least one LED chip, the heat sink 1113 and a lead frame or a circuit board, wherein the lead frame or circuit board disposes the at least two terminals 1112. The at least two terminals 1112 are exposed from the LED package structure 111 for being electrically connected to a circuit (not drawn) of the upper surface 1121 of the load board 112, so that the LED package structure 111 can be supplied an outer power source through the load board 112, thereby generating a specific color light.

Please again refer to FIG. 1B, the heat-dissipating base 12 of the first embodiment of the present invention has a first loading surface 121 and a second loading surface 122, wherein, the height of the second loading surface 122 may be lower than that of the first loading surface 121 for the load board 112 being disposed on the second loading surface 122 of the heat-dissipating base 12. The height of the upper surface 1121 of the load board 112 is equal to that of the first loading surface 121, and the lower surface 1122 of the load board 112 directly contacts against the second loading surface 122, namely there are a parallel arrangement relationship. Furthermore, the heat sink 1113 of the at least one LED package structure 111 is exposed from the bottom surface 1111, and the bottom surface 1111 fixedly contacts against the first loading surface 121 of the heat-dissipating base 12, thereby the heat sink 1113 and the heat-dissipating base 12 being directly and thermally contacted with each other for enhancing a heat transfer coefficient of the at least one LED package structure 111. The heat-dissipating base 12 is made of heat conduction materials having good heat-dissipating efficiency, such as each metal or alloy, especially metal heat-dissipating plate, heat-dissipating aluminum extrusion or alloy heat-dissipating plate, which are made of aluminum, aluminum alloy or materials including aluminum. It is advantageous that the heat sink 1113 of the at least one LED package structure 111 and the load board 112 can directly and thermally contact with the heat-dissipating base 12, for taking the aid of a good heat-dissipating characteristic of the heat-dissipating base 12 to conduct and dissipate heat. So it helps to enhance the heat-dissipating efficiency of the heat dissipating structure of the light source 10 and to achieve the object of fast reducing temperature. When necessary, the part of the bottom surface 1111 and the heat sink 1113 of the at least one LED package structure 111, which directly contacts with the mention first loading surface 121 of the heat-dissipating base 12, may be coated with an appropriate amount of heat-dissipating glue (not drawn), thereby the heat sink 1113 of the at least one LED package structure 111 and the heat-dissipating base 12 having a better heat-dissipating efficiency therebetween.

Please again refer to FIG. 1B, the load board 112 of the first embodiment of the present invention is disposed on the mention second loading surface 122 of the heat-dissipating base 12. The at least one LED package structure 111 simultaneously contacts with the first loading surface 121 of the heat-dissipating base 12 by the aid of the bottom surface 1111 and the heat sink 1113, and is electrically connected to the upper surface 1121 of the load board 112 by the at least two terminals 1112, wherein when the load board 112 is disposed on the second loading surface 122 of the heat-dissipating base 12, the upper surface 1121 of the load board 112 and the first loading surface 121 of the heat-dissipating base 12 may be equal height and even, but not be limited to this. And the load board 112 may be a printed circuit board, an anodizing aluminum board or other boards being capable of disposing surface circuit patterns.

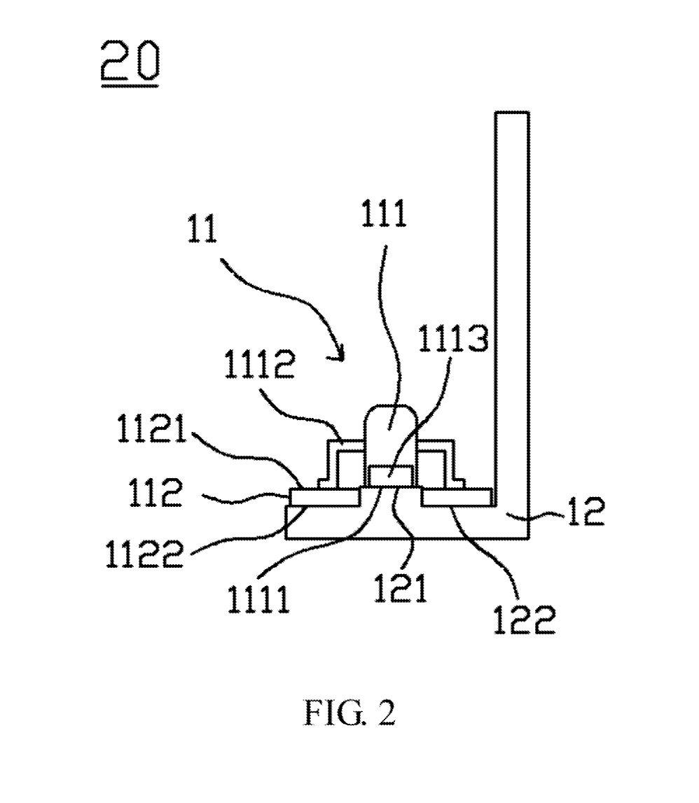

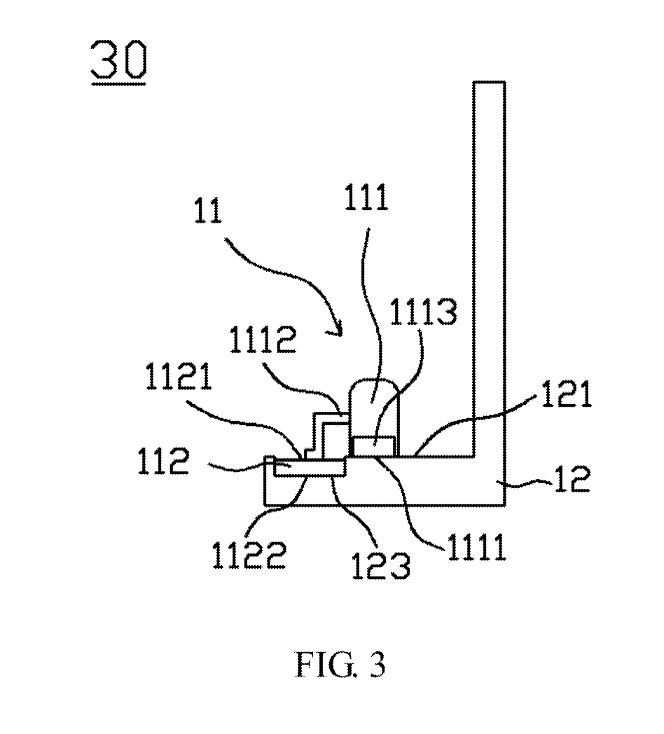

Please orderly refer to FIGS. 2 and 3, a second and third preferred embodiments of the present invention are similar to the heat dissipating structure of the light source 10 of the first embodiment of the present invention, and generally still employ same component names and marks. But the different feature of the second and third preferred embodiments is that: the heat dissipating structure of the light source 20, 30 of the second and third preferred embodiments can further improve the heat-dissipating base 12. The present invention will be explained in detail in the following text.

Please refer to FIG. 2, FIG. 2 discloses a side view of the heat dissipating structure of the light source 20 of the second preferred embodiment of the present invention. In the second embodiment of the present invention, the heat dissipating structure of the light source 20 mainly includes at least one light bar 11 and a heat-dissipating base 12. The different feature of the second embodiment is that: the heat-dissipating base 12 each has multi-second loading surfaces 122, and the at least one light bar 11 includes multi-load boards 112, wherein the multi-load boards 112 are separately disposed on the multi-second loading surfaces 122 of the heat-dissipating base 12, for example, having two load boards 112 and two second loading surfaces 122. Moreover, the at least two terminals 1112 of the at least one LED package structure 111 are disposed on at least two sides of the at least one LED package structure 111, and are separately and electrically connected to the multi-load boards 112. Therefore the heat sink 1113 of the at least one LED package structure 111 and the multi-load boards 112 directly contact with the heat-dissipating base 12, for taking the aid of the good heat-dissipating characteristic of the heat-dissipating base 12 to directly conduct and dissipate heat.

Please refer to FIG. 3, FIG. 3 discloses a side view of the heat dissipating structure of the light source 30 of the third preferred embodiment of the present invention. In the third embodiment of the present invention, the heat dissipating structure of the light source 30 mainly includes at least one light bar 11 and a heat-dissipating base 12. The different feature of the third embodiment is that: the heat-dissipating base 12 has at least one groove-shaped second loading surface 123. The height of the groove-shaped second loading surface 123 is lower than that of the first loading surface 121, and the at least one light bar 11 each includes at least one load board 112, wherein the at least one load board 112 is separately received and placed on the groove-shaped second loading surface 123 of the heat-dissipating base 12, and the at least two terminals 1112 of the at least one LED package structure 111 are simultaneously and electrically connected to the at least one load board 112. Therefore the heat sink 1113 of the at least one LED package structure 111 and the at least one load board 112 directly and thermally contact with the heat-dissipating base 12, for taking the aid of the good heat-dissipating characteristic of the heat-dissipating base 12 to directly conduct and dissipate heat.

As shown in FIGS. 1B, 2 and 3, the advantage of the above features of the first, second and third embodiments of the present invention is that: the at least one LED package structure 111, the at least one load board 112 and the heat-dissipating base 12 are combined together, wherein the heat-dissipating base 12 directly carries and thermally contacts with the bottom surface 1111 and the heat sink 1113 of the at least one LED package structure 111 and the at least one load board 112, so being advantageous that the heat sink 1113 of the at least one LED package structure 111 and the at least one load board 112 can take the aid of the good heat-dissipating characteristic of the heat-dissipating base 12 to directly conduct and dissipate heat, for relatively enhancing the heat-dissipating efficiency and the usage life of the at least one LED package structure 111. Moreover, the at least two terminals 1112 of the at least one LED package structure 111 are directly and electrically connected to the at least one load board 112, and the heat sink 1113 directly and thermally contacts with the heat-dissipating base 12. So it does not need to take the aid of an aluminum extrusion material. That not only may simplify the structure and the assembly flow, but also may shorten working hours, and is advantageous for decreasing the assembly defective rate. In addition, the first loading surface 121 and the at least one second loading surface 122 or the at least one groove-shaped second loading surface 123 of the heat-dissipating base 12 are integrally formed to replace the existed mentioned aluminum extrusion material, thereby also saving the component cost. Therefore it is helpful for saving the manufacturing time of the heat dissipating structure of the light source 10, 20, 30 and the whole cost, and for enhancing the assembly yield rate, thereby achieving the object of the lower product cost.

The present invention has been illustrated by the above embodiments, but the above embodiments only are used as examples for implementing the present invention. It must need to be pointed out that the exposed embodiments cannot limit the scope of the present invention. Oppositely, the modification and equivalent structures included within the spirit and scope of the appended claims are also included within the scope of the present invention.

What is claimed is:

1. A heat dissipating structure of a light source, wherein the heat dissipating structure of the light source comprises:
at least one light bar, each including:
at least one LED package structure, each having at least two terminals disposed on at least two sides of the LED package structure; and
at least one load board electrically connected to the at least two terminals of the LED package structure; and
a heat-dissipating base having a first loading surface and at least one second loading surface;
wherein the LED package structure of the light bar thermally contacts with the first loading surface of the heat-dissipating base, and the at least one load board of the light bar is separately received and placed on the second loading surface of the heat-dissipating base.

2. The heat dissipating structure of the light source as claimed in claim 1, wherein the height of the second loading surface is lower than that of the first loading surface.

3. The heat dissipating structure of the light source as claimed in claim 2, wherein the second loading surface of the heat-dissipating base is groove-shaped.

4. The heat dissipating structure of the light source as claimed in claim 2, wherein the at least one load board is a printed circuit board, and the height of a top surface of the at least one load board is equal to that of the first loading surface.

5. The heat dissipating structure of the light source as claimed in claim 1, wherein the heat-dissipating base is a heat-dissipating aluminum extrusion.

6. A heat dissipating structure of a light source, wherein the heat dissipating structure of the light source comprises:
at least one load board;
at least one LED package structure being electrically connected to the at least one load board; and
a heat-dissipating base having a first loading surface and at least one second loading surface;
wherein the LED package structure thermally contacts with the first loading surface of the heat-dissipating base, and the at least one load board is separately disposed on the second loading surface of the heat-dissipating base.

7. The heat dissipating structure of the light source as claimed in claim 6, wherein the height of the second loading surface is lower than that of the first loading surface.

8. The heat dissipating structure of the light source as claimed in claim 7, wherein the second loading surface of the heat-dissipating base is groove-shaped.

9. The heat dissipating structure of the light source as claimed in claim 7, wherein the at least one load board is a printed circuit board, and the height of a top surface of the at least one load board is equal to that of the first loading surface.

10. The heat dissipating structure of the light source as claimed in claim 7, wherein the heat-dissipating base has at least two of the second loading surfaces, and the at least one LED package structure includes at least two terminals, which are disposed on at least two sides of the LED package structure and are separately and electrically connected to at least two of the load board.

11. The heat dissipating structure of the light source as claimed in claim 6, wherein the heat-dissipating base is a heat-dissipating aluminum extrusion.

12. A backlight module of a heat dissipating structure of a light source, wherein the backlight module comprises a heat dissipating structure of a light source, which including:
at least one load board;
at least one LED package structure electrically connected to the at least one load board; and
a heat-dissipating base having a first loading surface and at least one second loading surface;
wherein the LED package structure thermally contacts with the first loading surface of the heat-dissipating base, and the at least one load board is separately disposed on the second loading surface of the heat-dissipating base.

13. The backlight module of the heat dissipating structure of the light source as claimed in claim 12, wherein the height of the second loading surface is lower than that of the first loading surface.

14. The backlight module of the heat dissipating structure of the light source as claimed in claim 13, wherein the second loading surface of the heat-dissipating base is groove-shaped.

15. The backlight module of the heat dissipating structure of the light source as claimed in claim 13, wherein the at least one load board is a printed circuit board, and the height of a top surface of the at least one load board is equal to that of the first loading surface.

16. The backlight module of the heat dissipating structure of the light source as claimed in claim 13, wherein the heat-dissipating base has at least two of the second loading surfaces, and the at least one LED package structure includes at least two terminals, which are disposed on at least two sides of the LED package structure and are separately and electrically connected to at least two of the load board.

17. The backlight module of the heat dissipating structure of the light source as claimed in claim 12, wherein the heat-dissipating base is a heat-dissipating aluminum extrusion.
